(19) United States
(12) Patent Application Publication
(10) Pub. No.: US 2014/0354711 A1
(43) Pub. Date: Dec. 4, 2014

(54) ORGANIC LIGHT EMITTING DISPLAY DEVICE AND METHOD OF DRIVING THE SAME

(71) Applicant: SAMSUNG DISPLAY CO., LTD., Yongin-City (KR)

(72) Inventors: Hai-Jung IN, Yongin-City (KR); Jung-Bae KIM, Yongin-City (KR); Bo-Yong CHUNG, Yongin-City (KR)

(73) Assignee: SAMSUNG DISPLAY CO., LTD., Yongin-City (KR)

(21) Appl. No.: 14/211,451

(22) Filed: Mar. 14, 2014

(30) Foreign Application Priority Data
May 30, 2013 (KR) 10-2013-0061664

(51) Int. Cl. G09G 3/32

(52) U.S. Cl. CPC G09G 3/3283
USPC 345/691; 345/82

(57) ABSTRACT

An organic light emitting display device includes pixels, a scan driver, a memory configured to store pixel data containing information indicative of threshold voltages and mobilities of first transistors in the pixels, a timing controller configured to modify one or more bits of first data to generate second data, the first data modified in response to the pixel data, a data driver configured to generate data signals based on the second data, and a control driver configured to supply a first control signal to a first control line commonly coupled to the pixels and a second control signal to a second control line, wherein each of the pixels is configured to store a data signal of a current frame and to emit light corresponding to a data signal of a previous frame.

### CROSS-REFERENCE TO RELATED APPLICATION

Korean Patent Application No. 10-2013-0061664, filed on May 30, 2013, and entitled, “Organic Light Emitting Display Device and Method of Driving the Same,” is incorporated by reference herein in its entirety.

### BACKGROUND

1. Field

One or more embodiments described herein relate to a display device.

2. Description of the Related Art

Various types of flat panel display devices have been developed. These devices outperform cathode ray tubes (CRT) devices in terms of weight and performance. One type of flat panel display device is an organic light emitting display device. This device displays images using organic light emitting diodes (OLED) that generate light based on a recombination of electrons and holes in an active layer. The organic light emitting display device has high response speed and is driven with low power consumption.

### SUMMARY

In accordance with one embodiment, an organic light emitting display device includes pixels in regions defined by scan lines and data lines, a scan driver configured to drive the scan lines, a memory configured to store pixel data containing information indicative of threshold voltages and mobilities of first transistors in the pixels, a timing controller configured to modify one or more bits of first data to generate second data, the first data modified in response to the pixel data, a data driver configured to generate data signals based on the second data and to supply the data signals to the data lines, and a control driver configured to supply a first control signal to a first control line commonly coupled to the pixels and a second control signal to a second control line. Each of the pixels is configured to store a data signal of a current frame and to emit light in response to an amount of current flowing from a first power supply to a second power supply, via an organic light emitting diode, corresponding to a data signal of a previous frame.

The timing controller may generate the second data to compensate for the threshold voltages and mobilities of the first transistors in the pixels.

The display device may further include a first power supply generator to generate the first power supply, and a second power supply generator to generate the second power supply.

The control driver may be to supply the first control signal during a first period of a frame and the second control signal during a second period of a frame.

The scan driver may sequentially supply scan signals to the scan lines during a third period of the frame.

The data driver may supply the data signals to the data lines to be synchronized with the scan signals.

The data driver may sequentially supply a bias voltage and a reference voltage to the data lines during the first period.

The bias voltage may be an off-bias voltage to turn off the first transistors.

The bias voltage may be an on-bias voltage to turn on the first transistors.

The reference voltage may be substantially equal to the bias voltage.

The reference voltage may be a voltage to turn off the first transistors.

At least one of the first power supply generator or the second power supply generator may control a voltage of the first power supply or the second power supply so that the pixels do not emit light during a period when the bias voltage is supplied.

At least one of the first power supply generator or the second power supply generator may control a voltage of the first power supply or the second power supply so that the pixels do not emit light during the first period and the second period.

Each of the pixels may include an organic light emitting diode having a cathode electrode coupled to the second power supply, a pixel circuit configured to control an amount of current to be supplied to the organic light emitting diode in response to a data signal of the previous frame, and a driver configured to store a data signal of a current frame and to deliver the data signal of the previous frame to the pixel circuit.

The pixel circuit may include a first transistor having a gate electrode coupled to a first node, a first electrode coupled to the first power supply, and a second electrode coupled to an anode electrode of the organic light emitting diode, a second transistor coupled between the first node and the data lines and turned on when the first control signal is supplied, and a first capacitor coupled between the first node and the first power supply.

The first transistor and the second transistor may be PMOS transistors.

The pixel circuit may include a first transistor having a gate electrode coupled to a first node, a first electrode coupled to the first power supply, and a second electrode coupled to an anode electrode of the organic light emitting diode, a second transistor coupled between the first node and the data lines and turned on when the first control signal is supplied, and a first capacitor coupled between the first node and the anode electrode of the organic light emitting diode.

The first transistor and the second transistor may be NMOS transistors.

The driver may include a third transistor coupled to the data lines and the second node and turned on when a scan signal is supplied, a fourth transistor coupled between the second node and the first node and turned on when the second control signal is supplied, and a second capacitor coupled between the second node and an initial power supply.

In accordance with another embodiment, a method of driving an organic light emitting display device includes modifying bits of first data, supplied in response to pixel data, to generate second data including information indicative of threshold voltages and mobilities of driving transistors in a plurality of pixels, each of the pixels storing a data signal of a current frame during a light-emitting period and emitting light in response to a data signal of a previous frame, generating data signals based on the second data, and supplying the data signals to the pixels.

The method may include controlling bit values of the second data to compensate for the threshold voltages and mobilities of the driving transistors

The pixel data may be stored in a memory before the display device is shipped.

Storing the pixel data in the memory may include supplying a reference data signal to the pixels, measuring light emitted from the pixels in response to the reference data signal, and generating the pixel data to compensate for light difference in the respective pixels.

### BRIEF DESCRIPTION OF THE DRAWINGS

Features will become apparent to those of skill in the art by describing in detail exemplary embodiments with reference to the attached drawings in which:

FIG. 1 illustrates an embodiment of an organic light emitting display device;

FIG. 2 illustrates an embodiment of a pixel in the device of FIG. 1;

FIG. 3 illustrates a first embodiment of driving waveforms for the pixel of FIG. 2 applied during a sensing period for storing pixel data in a memory;

FIG. 4 is a waveform diagram illustrating driving waveforms according to the first embodiment;

FIG. 5 is a waveform diagram illustrating a second embodiment of driving waveforms;

FIG. 6 is a waveform diagram illustrating a third embodiment of driving waveforms;

FIG. 7 illustrates another embodiment of a pixel;

FIG. 8 illustrates an embodiment of driving waveforms for the pixel of FIG. 7 applied during a sensing period for storing pixel data in a memory;

FIG. 9 illustrates another embodiment of driving waves corresponding to a sensing period for storing pixel data in a memory;

FIG. 10 illustrates another embodiment of driving waveforms corresponding to a sensing period for storing pixel data in a memory; and

FIG. 11 illustrates another embodiment of driving waveforms corresponding to a sensing period for storing pixel data in a memory.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will be understood that when an element is referred to as being “between” two elements, it may be the only element between the two elements, or one or more intervening elements may also be present. Like reference numerals refer to like elements throughout.

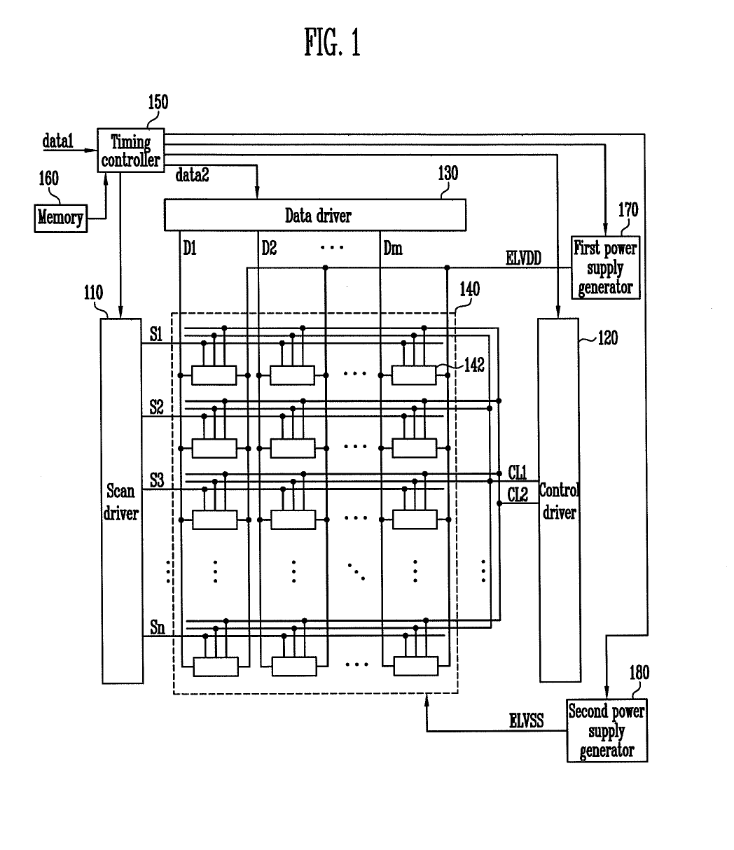

FIG. 1 illustrates an embodiment of an organic light emitting display device which includes a scan driver 10, a control driver 120, a data driver 130, a pixel unit 140, a timing controller 150, a memory 160, a first power supply generator 170, and second power supply generator 180.

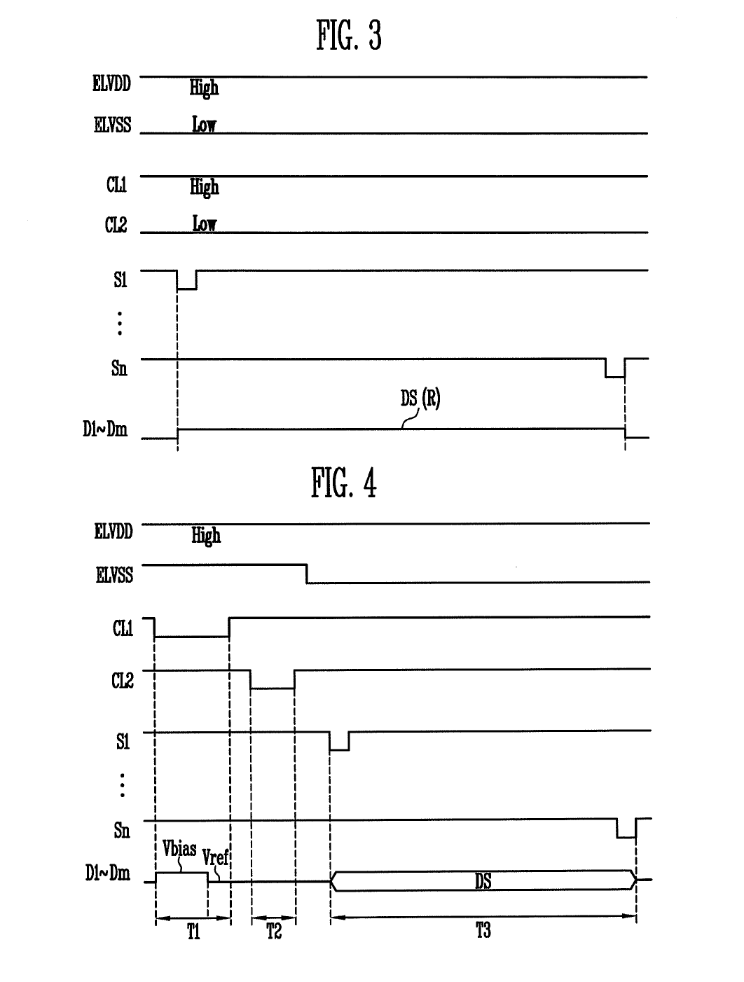

The scan driver 110 supplies scan signals to scan lines S1 to Sn. For example, the scan driver 110, an embodiment of which is illustrated in FIG. 4, may supply the scan signals to the scan lines S1 to Sn for a third period T3 of one frame 1F sequentially. The scan signals are set as a voltage where transistors included in pixels 142 may be turned on. For example, the scan signals are set as a low voltage when the pixels 142 include PMOS transistors and as a high voltage when the pixels 142 include NMOS transistors.

The control driver 120 supplies a first control signal to a first control line CL1 commonly coupled to respective pixels 142 and a second control signal to a second control line CL2, respectively. For example, the control driver 120 supplies the first control signal for a first period T1 of one frame 1F and the second control signal for a second period T2. The first control signal and the second signal are set to voltages that turn on transistors included in the pixels 142.

The data driver 130 is provided with second data (data2) and creates data signals in response to the second data data2. The data driver 130 supplies data signals to data lines D1 to Dm to be synchronized with scan signals to be supplied to scan lines S1 to Sn for a third period T3 of one frame 1F. The data driver 130 supplies a bias voltage Vbias to the data lines D1 to Dm for some of the first period T1 and a reference voltage Vref for the remaining part of the first period T1. The bias voltage Vbias is set as a voltage where driving transistors respectively included in the pixels 142 can be turned on (an on-bias voltage) or off (an off-bias voltage). The reference voltage Vref is to initialize a gate electrode of the driving transistor and is set as a predetermined voltage. For example, the reference voltage Vref may be set as the same voltage as the bias voltage Vbias.

The pixel unit 140 includes the pixels 142 positioned in regions defined by the scan lines S1 to Sn and the data lines D1 to Dm. The pixels 142 charge data signals (current data signals) of a current frame for the third period T3, and at the same time emit light in response to data signals (previous data signals) of a previous frame. The pixels 142 control an amount of current flowing from a first power supply ELVDD to a second power supply ELVSS, via an organic light emitting diode, in response to the previous data signals for the third period T3.

The memory 160 stores pixel data containing information about threshold voltages and mobilities of the driving transistors which are included in the pixels 142 respectively. The pixel data may be stored in the memory 160, for example, before the panel is shipped.

The first power supply generator 170 generates the first power supply ELVDD and supplies the generated first power supply ELVDD to the pixels 142. The first power supply generator 170 may supply the first power supply ELVDD at a predetermined (e.g., high or low) voltage, or at a high voltage and a low voltage at different times, in one frame 1F based on a driving method. The high voltage of the first power supply ELVDD may be a voltage where the pixels 142 can emit light. The low voltage of the first power supply ELVDD may be a voltage where the pixels 142 do not emit light.

The second power supply generator 180 generates the second power supply ELVSS and supplies the generated second power supply ELVSS to the pixels 142. The second power supply generator 180 may supply the second power supply ELVSS at a predetermined (e.g., high or low) voltage, or at a high voltage and a low voltage at different times, during one frame period 1F based on a driving method. The high voltage of the second power supply ELVSS may be a voltage where the pixels 142 do not emit light. The low voltage of the second power supply ELVSS may be a voltage where the pixels 142 can emit light.

The timing controller 150 modifies bits of first data, supplied from an external source, to create second data data2 in response to the pixel data. The second data data2 may be created such that the threshold voltages and the mobilities of the driving transistors respectively included in the pixels 142 can be compensated. In addition, the timing controller 150 may control the scan driver 110, the control driver 120, the data driver 130, the first power supply generator 170, and the second power supply generator 180 in response to synchronizing signals supplied from an external source.

In FIG. 1, the control lines CL1 and CL2 are shown to be coupled to the control driver 120. However, the control lines CL1 and CL2 may be coupled to the scan driver 110 in other embodiments.

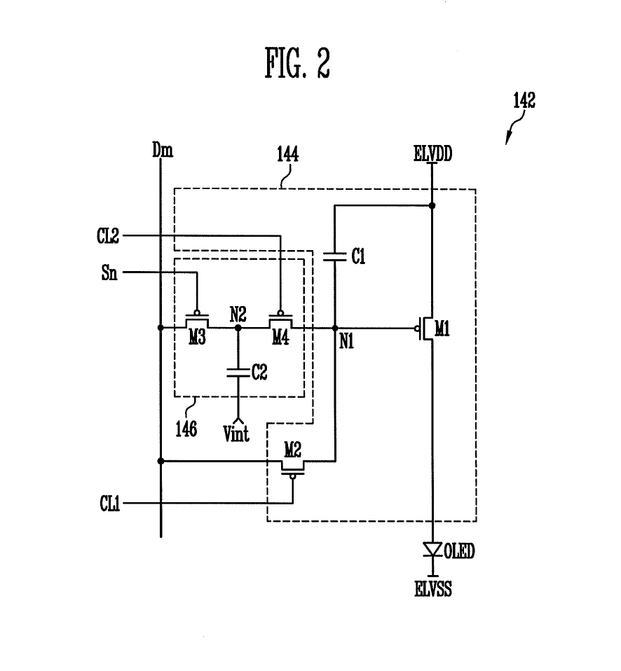

FIG. 2 illustrates an embodiment of a pixel, which, for example, may be representative of the pixels included in the pixels in FIG. 1. In FIG. 2, for convenience sake, a pixel coupled to the nth scan line Sn and the mth data line Dm will be illustrated.

Referring to FIG. 2, pixel 142 includes an organic light emitting diode (OLED), a pixel circuit 144 configured to control an amount of current supplied to the OLED to correspond to a previous data signal, and a driver 146 configured to store a current data signal.

An anode electrode of the OLED is coupled to the pixel circuit 144 and a cathode electrode of the OLED is coupled to the second power supply ELVSS. The OLED generates light with predetermined brightness corresponding to the amount of current supplied from the pixel circuit 144. The first power supply ELVDD may be set to have a low voltage while the second power supply ELVSS is set to have a high voltage for the third period T3 when light emits.

The pixel circuit 144 controls the amount of current supplied to the OLED to correspond to a previous data signal. The pixel circuit 144 includes first to fourth transistors M1 to M4 and a first capacitor C1.

A first electrode of the first transistor M1 (that is, a driving transistor) is coupled to the first power supply ELVDD and a second electrode of the first transistor M1 is coupled to the anode electrode of the OLED. A gate electrode of the first transistor M1 is coupled to a first node N1. The first transistor M1 controls the amount of current supplied to the OLED to correspond to a voltage applied to the first node N1.

A first electrode of the second transistor M2 is coupled to the data line Dm and a second electrode of the second transistor M2 is coupled to the first node N1. A gate electrode of the second transistor M2 is coupled to the first control line CL1. The second transistor M2 is turned on when the first control signal is supplied to the first control line CL1 to couple the data line Dm to the first node N1.

The first capacitor C1 is coupled between the first node N1 and the first power supply ELVDD. The first capacitor C1 charges a voltage corresponding to the previous data signal supplied from the driver 146.

The driver 146 stores the current data signal supplied from the data line Dm and supplies the previous data signal stored in the previous frame to the pixel circuit 144. The driver 146 includes a third transistor M3, a fourth transistor M4, and a second capacitor C2.

A first electrode of the third transistor M3 is coupled to the data line Dm and a second electrode of the third transistor M3 is coupled to the second node N2. A gate electrode of the third transistor M3 is coupled to the scan line Sn. The third transistor M3 is turned on, when the scan signal is supplied to the scan line Sn, to supply the data signal from the data line Dm to the second node N2.

A first electrode of the fourth transistor M4 is coupled to the second node N2 and a second electrode of the fourth transistor M4 is coupled to the first node N1. A gate electrode of the fourth transistor M4 is coupled to the second control line CL2. The fourth transistor M4 is turned on, when the second control signal is supplied to the second control line CL2, to electrically couple the second node N2 to the first node N1.

The second capacitor C2 is coupled between the second node N2 and a fixed power supply (for example, an initial power supply Vint). The second capacitor C2 charges a voltage corresponding to the current data signal when the third transistor M3 is turned on.

FIG. 3 illustrates a first embodiment of driving waveforms corresponding to a sensing period for storing pixel data in a memory. The driving waveforms of the sensing period may be supplied to the pixel unit 140 more than once before a panel is shipped.

Referring to FIG. 3, a high voltage of the first power supply ELVDD and a low voltage of the second power supply ELVSS are supplied for the sensing period, in order to set the pixels in emission state. The second control signal is supplied to the second control line CL2 for the sensing period, in order to turn on the fourth transistors M4 in the respective pixels 142. A reference data signal DS(R) is supplied to the data lines D1 to Dm for the sensing period. The reference data signal DS(R) is set to a specific data signal within a voltage range of the data signals capable of being supplied from the data driver 130.

As the scan signal is supplied to the scan lines S1 to Sn sequentially, the third transistors M3 in the respective pixels 142 in each horizontal line are turned on. When the third transistors M3 are turned on, the reference data signal DS(R) is supplied to the first node N1. When the reference data signal DS(R) is supplied to the first node N1, the first transistor M1 supplies current to the OLED to correspond to the reference data signal DS(R).

All of the pixels 142 generate light with predetermined brightness to correspond to the same data signal DS(R) for the sensing period. After that, light from the respective pixels 142 is measured using an external measuring equipment and pixel data is generated and stored in the memory 160 in order to allow that light difference to be compensated. The pixel data contains information about threshold voltages and mobilities of the first transistors M1 which are included in the respective pixels 142.

FIG. 4 illustrates a first embodiment of waveforms for driving the pixel. Referring to FIG. 4, the one frame 1F is divided into the first period T1, a second period T2, and a third period T3. The first period T1 is to apply a bias voltage Vbias to the first transistors M1 included in the respective pixels 142 and to initialize the first node N1. The second period is to supply the previous data signal stored in the driver 146 to the pixel circuit 144. The third period T3 is to store the current data signal in the driver 146 and to emit light to correspond to the previous data signal. The operation process will be described in detail.

First, in the first period T1 and the second period T2, the high value of the second power supply ELVSS is supplied in order to set the OLED in a non-emission state. In the first period T1, the first control signal is supplied to the first control line CL1, and the bias voltage Vbias and the reference voltage Vref are supplied to the data line Dm.

When the first control signal is supplied to the first control line CL1, the second transistor M2 is turned on. When the second transistor M2 is turned on, the bias voltage Vbias and the reference voltage Vref supplied to the data line Dm is supplied to the first node N1, sequentially.

When the bias voltage Vbias is supplied to the first node N1, the first transistor M1 is initialized to an on-bias state or an off-bias state corresponding to the bias voltage Vbias. For example, when the on-bias voltage Vbias is supplied to the first node N1, the first transistor M1 is set in the on-bias state, so that a voltage characteristic curve of the first transistor M1 is initialized to the on-bias state. When the off-bias voltage Vbias is supplied to the first node N1, the first transistor M1 is set in the off-bias state, so that a voltage characteristic curve of the first transistor M1 is initialized to the off-bias state.

After that, the reference voltage Vref is supplied to the first node N1. When the reference voltage Vref is supplied to the first node N1, voltages of the first nodes N1 of all the pixels 142 are initialized to the reference voltage Vref. Here, the reference voltage Vref may be set to the same voltage as the bias voltage supplied for the previous period.

In the second period T2, the second control signal is supplied to the second control line CL2. When the second control signal is supplied to the second control line CL2, the fourth transistor M4 is turned on. When the fourth transistor M4 is turned on, the second node N2 is electrically coupled to the first node N1. At this time, the first capacitor C1 charges to a voltage of the previous data signal stored in the second capacitor C2. In the second period T2, voltages of a source electrode (first electrode) and the gate electrode of the first transistor M1 may be set as equation 1 by charge sharing of the first capacitor C1 and the second capacitor C2.

$${V}_{sg ( M 1 )} = ELVDD - \frac{C 2 Vdata + C 1 Vref}{C 2 + C 1} \qquad ( 1 )$$

In equation 1, Vdata indicates a voltage of the previous data signal. Because all of the pixels 142 are set to a turn-off state for the second period T2, voltage drop of the first power supply ELVDD does not happen. As a result, in all of the pixels 142, a voltage charged to the first capacitor C1 is determined to correspond to the same voltage of the first power supply ELVDD.

In the third period T3, the low value of the second power supply ELVSS is supplied. Then, first transistor M1 controls an amount of current flowing from the first power supply ELVDD to the second power supply ELVSS, via the OLED, to correspond to the voltage of the previous data signal stored in the first capacitor C1. A voltage of the previous data signal may be such that the threshold voltage the mobility of the first transistor M1 is compensated to correspond to the pixel data, so that the OLED may generate light with desired brightness.

In addition, in the third period T3, the voltages of the first power supplies ELVDD at every pixel 142 may be set to be different from each other, to correspond to the voltage drop of the first power supply. However, the voltage of the first node N1 may vary to correspond to a voltage change of the first power supply ELVSS, by the coupling the first capacitor C1. Thus, an image with desired brightness may be displayed regardless of the voltage drop of the first power supply ELVDD (that is, the voltage expressed by equation 1 is maintained regardless of the voltage drop of the first voltage drop).

The scan signals are sequentially supplied to the scan lines S1 to Sn. When the scan signal is supplied to the nth scan line Sn, the third transistor M3 is turned on. When the third transistor M3 is turned on, the current data signal supplied from the data line Dm is stored in the second capacitor C2. In one embodiment, the above-described processes are repeated to implement a desired gray scale value.

In addition, the data driver 130 generates the data signals using the second data data2. The second data data2 has bits set to compensate the difference between the first transistors M1 included in the respective pixels 142 to correspond to the pixel data, so that an image with uniform brightness may be displayed.

FIG. 5 illustrates a second embodiment of driving waveforms applied in one frame 1F, divided into a first period T1, a second period T2, and a third period T3.

In a portion of the first period T1, the low value of the first power supply ELVDD is supplied to set the OLED in a non-emission state. In the first period T1, the first control signal is supplied to the first control line CL1, and the bias voltage Vbias and the reference voltage Vref are sequentially supplied to the data line Dm. The bias voltage Vbias overlaps the low value of the first power supply ELVDD.

When the first control signal is supplied to the first control line CL1, the second transistor M2 is turned on. When the second transistor M2 is turned on, the bias voltage Vbias and the reference voltage Vref supplied to the data lines Dm are sequentially supplied to the first node N1.

When the bias voltage Vbias is supplied to the first node N1, the first transistor M1 is initialized in an on-bias state or an off-bias state to correspond to the bias voltage Vbias. The bias voltage Vbias is set to an on-bias voltage capable of turning the first transistor M1 on or to an off-bias voltage capable of turning the first transistor M1 off

In a remaining portion of the first period T1, the reference voltage Vref is supplied to the first node N1. In this remaining portion of the first period T1, the high value of the first power supply ELVDD is supplied. When the reference voltage Vref is supplied to the first node N1, the voltage of the first node N1 of every pixel 142 is initialized to the reference voltage Vref. The reference voltage Vref may be set to turn the first transistor M1 off. For example, the reference voltage Vref may be set to the same voltage as the off-bias voltage. When the first transistor M1 is turned off for a period where the reference voltage Vref is supplied, unnecessary current may not flow through the OLED.

In the second period T2, the second control signal is supplied to the second control line CL2 to turn on the fourth transistor M4. When the fourth transistor M4 is turned on, the second node N2 is electrically coupled to the first node N1. At this time, the first capacitor C1 charges to a voltage of the previous data signal stored in the second capacitor C2. In the second period T2, the voltages of the source electrode (first electrode) and the gate electrode of the first transistor M1 may be set based on equation 1, by charge sharing of the first capacitor C1 and the second capacitor C2.

The high value of the first power supply ELVDD and the low value of the second power supply ELVSS are supplied for the second period T2. Thus, the first transistor M1 controls an amount of current flowing from the first power supply ELVDD to the second power supply ELVSS, via the OLED, to correspond to the voltage of the previous data signal stored in the first capacitor C1. Thus, in the second embodiment, the OLED emits light for the second period T2 and the third period T3.

For the third period T3, the scan signals are sequentially supplied to the scan lines S1 to Sn. When the scan signal is supplied to the nth scan line Sn, the third transistor M3 is turned on. When the third transistor M3 is turned on, the current data signal supplied from the data line Dm is stored in the second capacitor C2. In one embodiment, the above-described processes are repeated to implement desired a gray scale value.

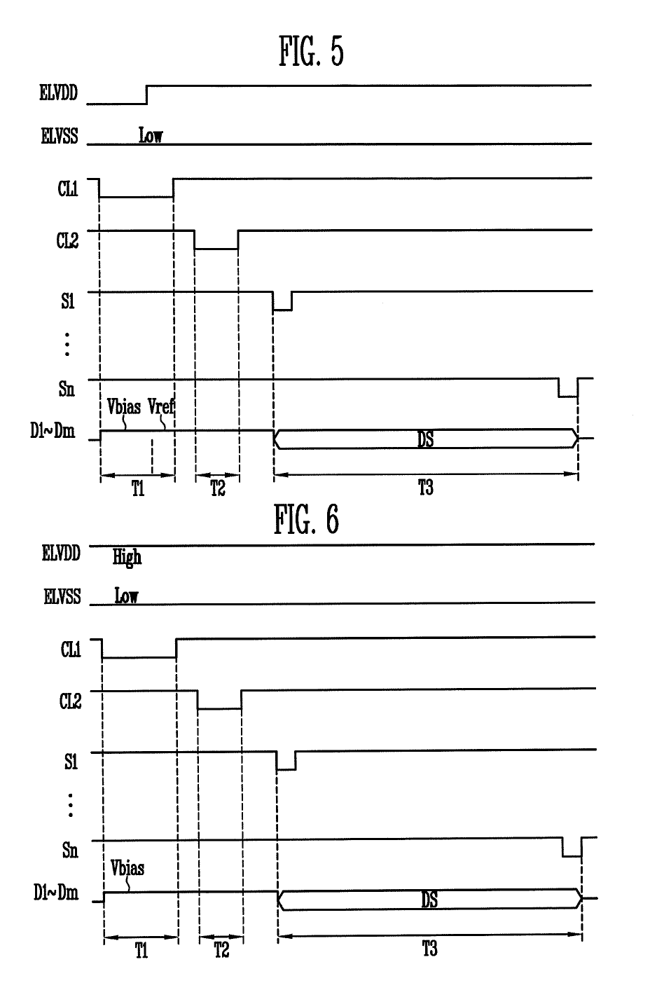

FIG. 6 illustrates a third embodiment of driving waveforms applied during one frame 1F, divided into the first period T1, a second period T2, and a third period T3.

In the first period T1, the first control signal is supplied to the first control line CL1 and the bias voltage Vbias is supplied to the data line Dm. When the first control signal is supplied to the first control line CL1, the second transistor M2 is turned on. When the second transistor M2 is turned on, the bias voltage Vbias supplied to the data line Dm is supplied to the first node N1. In this case, the bias voltage Vbias is set to a voltage where the first transistor M1 is turned off (that is, an off-bias voltage). At this time, in the first period T1, the first transistor M1 is initialized as an off-bias state.

In the second period T2, the second control signal is supplied to the second control line CL2 to turn on the fourth transistor M4. When the fourth transistor M4 is turned on, the second node N2 is electrically coupled to the first node N1. At this time, the first capacitor C1 charges a voltage of the previous data signal stored in the second capacitor C2. In the second period T2, the voltages of the source electrode (first electrode) and the gate electrode of the first transistor M1 may be set based on equation 1, by charge sharing of the first capacitor C1 and the second capacitor C2.

In the second period T2, the first transistor M1 controls an amount of current flowing from the first power supply ELVDD to the second power supply ELVSS, via the OLED, to correspond to the voltage of the previous data signal stored in the first capacitor C1. Thus, in the third embodiment, for the second period T2 and the third period T3, the OLED emits light.

In the third period T3, the scan signals are sequentially supplied to the scan lines S1 to Sn. When the scan signal is supplied to the nth scan line Sn, the third transistor M3 is turned on. When the third transistor M3 is turned on, the current data signal supplied from the data line Dm is stored in the second capacitor C2. In one embodiment, the above-described processes are repeated to implement a desired gray scale value.

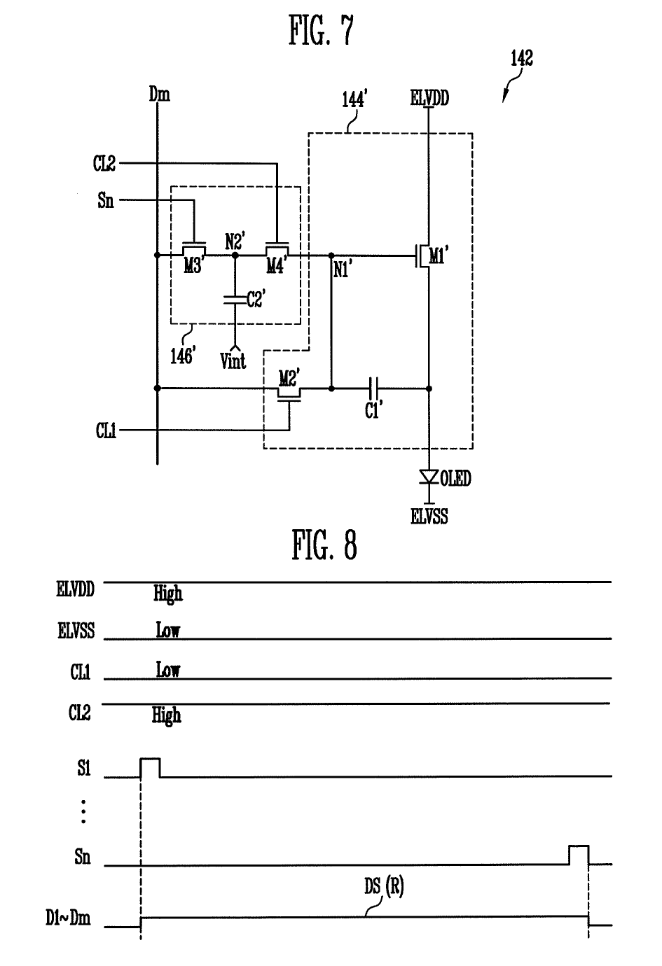

FIG. 7 illustrates another embodiment of a pixel 142. In this embodiment, the PMOS transistors M1 to M4 included in the pixel 142 according to prior embodiments are replaced with NMOS transistors M1′ to M4′.

Referring to FIG. 7, pixel 142 includes an organic light emitting diode OLED, a pixel circuit 144′, and a driver 146′. The OLED generates light with predetermined brightness to correspond to an amount of current supplied from the pixel circuit 144′.

The pixel circuit 144′ controls the amount of current supplied to the OLED to correspond to the previous data signal. The pixel circuit 144 includes a first transistor M1′, a second transistor M2′, and a first capacitor C1′. The first capacitor C1′ is coupled between a first node N1′ and an anode electrode of the OLED. The first capacitor C1′ charges a voltage corresponding to the previous data signal supplied from the driver 146′.

The driver 146′ stores the current data signal supplied from the data line Dm and supplies the previous data signal stored in the previous frame to the pixel circuit 144′. The driver 146′ includes a third transistor M3′, a fourth transistor M4′, and a second capacitor C2′.

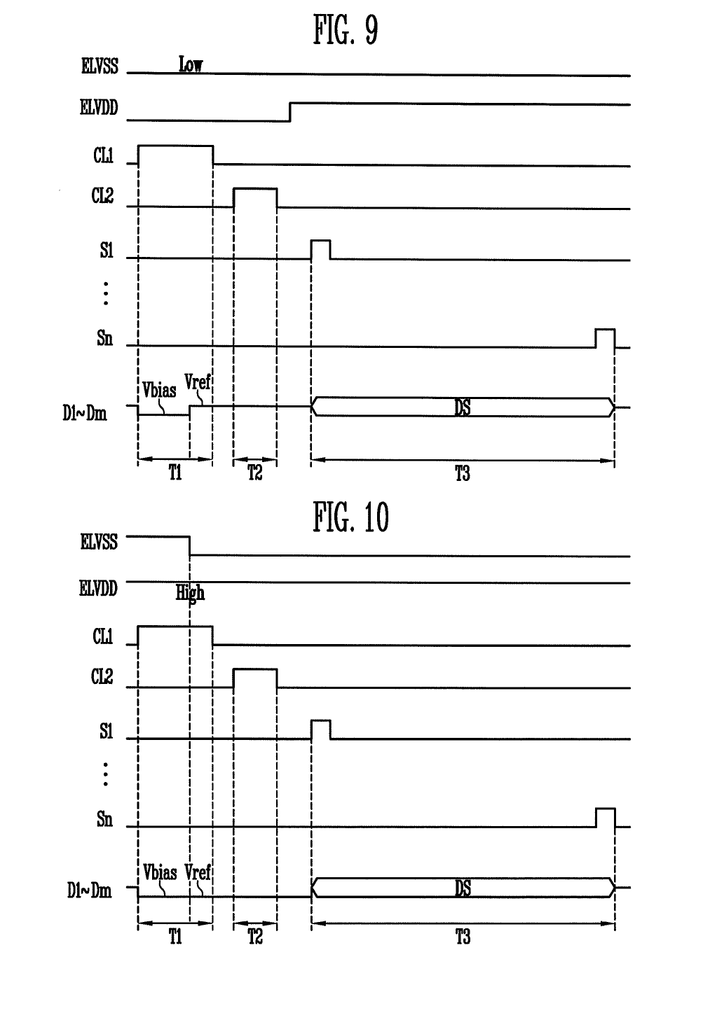

FIG. 8 illustrates another embodiment of driving waveforms for a pixel such as shown in FIG. 7 applied during a sensing period for storing pixel data in a memory. The driving waveforms in FIG. 8 are substantially identical to those in FIG. 3, except the polarities of signals are changed to drive the NMOS transistors.

In this embodiment, a second control signal CL2 is supplied for a sensing period to turn on the fourth transistors M4′ included in the respective pixels 142. In the sensing period, a reference data signal DS(R) is supplied to data lines D1 to Dm.

Then, scan signals are sequentially supplied to scan lines S1 to Sn to turn on the third transistors M3′ in the respective pixels 142 each horizontal line. When the third transistors M3′ are turned on, the reference data signal DS(R) is supplied to the first node N1. When the reference data signal DS(R) is supplied to the first node N1, the first transistor M1′ supplies current to the OLED to correspond to the reference data signal DS(R).

Then, light from the respective pixels 142 are measured using an external measuring equipment and pixel data is generated and stored in the memory 160 so that light difference may be compensated. The pixel data contains information about threshold voltages and mobilities of the first transistors M1 which are included in the respective pixels 142.

FIG. 9 illustrates a fourth embodiment of driving waveforms for a pixel implemented with NMOS transistors (e.g., as shown in FIG. 7) applied during a sensing period for storing pixel data in a memory. The driving waveforms in FIG. 9 are substantially identical to those in FIG. 4, except for changed polarities of signals to drive the NMOS transistors.

Referring to FIG. 9, in a first period T1 and a second period T2 of one frame 1F, a low value of the first power supply ELVDD is supplied to set the OLED in a non-emission state. In the first period T1, a first control signal is supplied to the first control line CL1 to turn on the second transistor M2′. When the second transistor M2′ is turned on, the bias voltage and the reference voltage Vref supplied to the data line Dm for the first period T1 are sequentially supplied to the first node N1.

When the bias voltage Vbias is supplied to the first node N1′, the first transistor M1′ is initialized to an on-bias state or an off-bias state corresponding to the bias voltage Vbias. When the reference voltage Vref is supplied to the first node N1′, the first nodes N1′ included in the respective pixels 142 are initialized to the reference voltage Vref. The reference voltage Vref may be set to the same voltage as the bias voltage Vbias.

In the second period T2, a second control signal is supplied to a second control line CL2 to turn on the fourth transistor M4′. When the fourth transistor M4′ is turned on, the second node N2′ is electrically coupled to the first node N1′. In this case, the first capacitor C1′ charges a voltage of a previous data signal stored in the second capacitor C2.

In the third period T3, the high first power supply ELVDD is supplied. Then, the first transistor M1′ controls an amount of current flowing from the first power supply ELVDD to the second power supply ELVSS, via the OLED, to correspond to the voltage of the previous data signal stored in the first capacitor C1.

In the third period T3, the scan signals are sequentially supplied to the scan lines S1 to Sn. When the scan signal is supplied to the nth scan line Sn, the third transistor M3′ is turned on. When the third transistor M3′ is turned on, the current data signal supplied from the data line Dm is stored in the second capacitor C2′. In one embodiment, the above-described processes are repeated to implement a desired gray scale value.

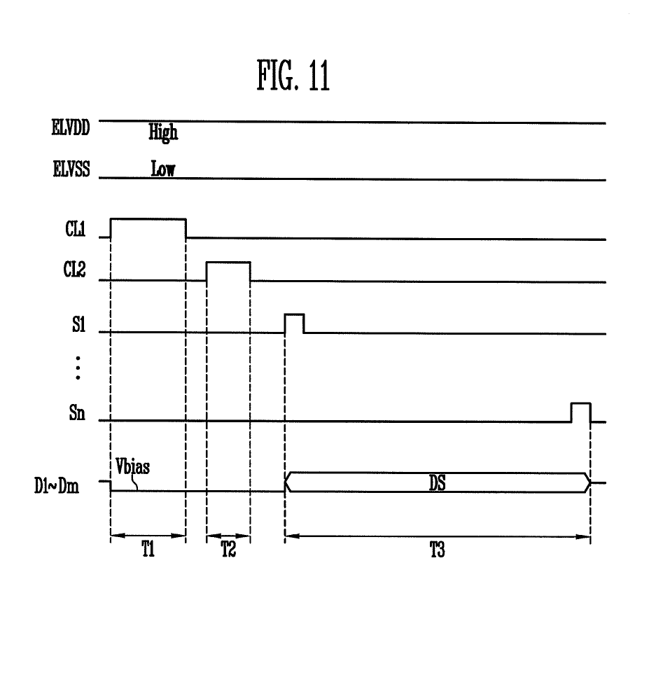

FIG. 10 illustrates a fifth embodiment of driving waveforms for a pixel implemented with NMOS transistors (e.g., as shown in FIG. 7) applied during a sensing period for storing pixel data in a memory. The driving waveforms in FIG. 10 are substantially identical to those in FIG. 5, except for changed polarities of signals to drive the NMOS transistors.

Referring to FIG. 10, in a portion of one frame 1F, the high value of the second power supply ELVSS is supplied to set the OLED in a non-emission state. In the first period T1, the first control signal is supplied and the second transistor M2′ is turned on. When the second transistor M2′ is turned on, the bias voltage Vbias and the reference voltage Vref supplied to the data line Dm for the first period T1 are sequentially supplied to the first node N1′. The bias voltage Vbias overlaps the high value of the second power supply ELVSS.

When the bias voltage Vbias is supplied to the first node N1′, the first transistor M1′ is initialized to an on-bias state or an off-bias state to correspond to the bias voltage Vbias. After that, the reference voltage Vref is supplied to the first node N1′ for the remaining portion of the first period T1, so that the first node N1′ is initialized to the reference voltage. In the remaining portion of the first period T1, the low value of the second power supply ELVSS is supplied. The reference voltage Vref may be set to turn off the first transistor M1′ or may be set to the same voltage as the off-bias voltage.

In the second period T2, the second control signal is supplied to the second control line CL2 to turn on the fourth transistor M4′. When the fourth transistor M4′ is turned on, the second node N2′ is electrically coupled to the first node N1′. At this time, the first capacitor C1′ charges a voltage of the previous data signal stored in the second capacitor C2′.

The high value of the first power supply ELVDD and the low value of the second power supply ELVSS are supplied for the second period T2. Thus, the first transistor M1′ controls an amount of current flowing from the first power supply ELVDD to the second power supply ELVSS, via the OLED, to correspond to the voltage of the previous data signal stored in the first capacitor C1′. Thus, in the fifth embodiment, the OLED emits light for the second period T2 and the third period T3.

In the third period T3, the scan signals are sequentially supplied to the scan lines S1 to Sn. When the scan signal is supplied to the nth scan line Sn, the third transistor M3′ is turned on. When the third transistor M3′ is turned on, the current data signal supplied from the data line Dm is stored in the second capacitor C2′. In one embodiment, the above-described processes are repeated to implement a desired gray scale value.

FIG. 11 illustrates a sixth embodiment of driving waveforms for a pixel implemented with NMOS transistors (e.g., as shown in FIG. 7) applied during a sensing period for storing pixel data in a memory. The driving waveforms in FIG. 11 are substantially identical to those in FIG. 6, except for changed polarities of signals to drive the NMOS transistors.

Referring to FIG. 11, in a first period T1 of one frame 1F, a first control signal is supplied to the first control line CL1 and a bias voltage Vbias is supplied to a data line Dm. When the first control signal is supplied to the first control line CL1, the second transistor M2′ is turned on. When the second transistor M2′ is turned on, the bias voltage Vbias from the data line is supplied to the first node N1′. In this case, the bias voltage Vbias is set to a voltage to turn off the first transistor M1′ (that is, off-bias voltage). In this case, the first transistor M1′ is initialized to an off-bias state for the first period T1.

In the second period T2, the second control signal is supplied to the second control line CL2 to turn on the fourth transistor M4′. When the fourth transistor M4′ is turned on, the second node N2′ is electrically coupled to the first node N1′. At this time, the first capacitor C1′ charges a voltage of the previous data signal stored in the second capacitor C2′.

In the second period T2, the first transistor M1′ controls an amount of current flowing from the first power supply ELVDD to the second power supply ELVSS, via the OLED, to correspond to the voltage of the previous data signal stored in the first capacitor C1′. Thus, in one embodiment, the OLED emits light for the second period T2 and the third period T3.

In the third period T3, the scan signals are sequentially supplied to the scan lines S1 to Sn. When the scan signal is supplied to the nth scan line Sn, the third transistor M3′ is turned on. When the third transistor M3′ is turned on, the current data signal supplied from the data line Dm is stored in the second capacitor C2′. In one embodiment, the above-described processes are repeated to implement a desired gray scale value.

According to one or more embodiments, the OLED generates light with a specific color to correspond to an amount of current supplied from the driving transistor. In another embodiment, the OLED may generate white light to correspond to the amount of current supplied from the driving transistor. In this case, a color image is implemented using a separated color filter.

By way of summation and review, an organic light emitting display device includes a plurality of pixels arranged at intersections between a plurality of data lines and scan lines, and power lines in matrix form. Each pixel commonly includes at least two transistors having an organic light emitting diode, a driving transistor, and at least one capacitor.

Also, in the organic light emitting display device, current flows through the OLEDs based on difference between threshold voltages of the driving transistors of the pixels. Because the threshold voltages may vary over time, different amounts of current may flow through the OLEDs and a non-uniform display quality may result. Thus, due to manufacturing factors of the driving transistors included in the respective pixels, characteristics of the driving transistors may change. It may be impractical to manufacture all transistors with identical characteristics included in an organic light emitting display device, resulting in a threshold voltage difference of the driving transistors.

Although methods have been considered to add compensation circuits, which include a plurality of transistors and capacitors, to the respective pixels, the addition of compensation circuits may complicate the design of the pixels and may result in a decrease in yield or aperture ratio.

According to one or more embodiments described herein, the threshold voltage and mobility of each driving transistor may be compensated using pixel data stored in a memory. Thus, an image with uniform brightness may be displayed. In addition, a compensation circuit to compensate for variations in the threshold voltage may be omitted from the pixels. Thus, the structure of the pixels may be simplified, which may improve yield and aperture ratio. In addition, the pixels may display uniform image regardless of voltage drop of the first power supply (IR-drop).

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An organic light emitting display device, comprising:
pixels in regions defined by scan lines and data lines;
a scan driver configured to drive the scan lines;
a memory configured to store pixel data containing information indicative of threshold voltages and mobilities of first transistors in the pixels;
a timing controller configured to modify one or more bits of first data to generate second data, the first data modified in response to the pixel data;
a data driver configured to generate data signals based on the second data and to supply the data signals to the data lines; and
a control driver configured to supply a first control signal to a first control line commonly coupled to the pixels and a second control signal to a second control line, wherein each of the pixels is configured to store a data signal of a current frame and to emit light in response to an amount of current flowing from a first power supply to a second power supply, via an organic light emitting diode, corresponding to a data signal of a previous frame.

2. The display device as claimed in claim 1, wherein the timing controller generates the second data to compensate for the threshold voltages and mobilities of the first transistors in the pixels.

3. The display device as claimed in claim 1, further comprising:
a first power supply generator to generate the first power supply; and
a second power supply generator to generate the second power supply.

4. The display device as claimed in claim 3, wherein the control driver is to supply the first control signal during a first period of a frame and the second control signal during a second period of a frame.

5. The display device as claimed in claim 4, wherein the scan driver sequentially supplies scan signals to the scan lines during a third period of the frame.

6. The display device as claimed in claim 5, wherein the data driver supplies the data signals to the data lines to be synchronized with the scan signals.

7. The display device as claimed in claim 4, wherein the data driver sequentially supplies a bias voltage and a reference voltage to the data lines during the first period.

8. The display device as claimed in claim 7, wherein the bias voltage is an off-bias voltage to turn off the first transistors.

9. The display device as claimed in claim 7, wherein the bias voltage is an on-bias voltage to turn on the first transistors.

10. The display device as claimed in claim 7, wherein the reference voltage is substantially equal to the bias voltage.

11. The display device as claimed in claim 7, wherein at least one of the first power supply generator or the second power supply generator controls a voltage of the first power supply or the second power supply so that the pixels do not emit light during a period when the bias voltage is supplied.

12. The display device as claimed in claim 11, wherein the reference voltage is a voltage to turn off the first transistors.

13. The display device as claimed in claim 4, wherein at least one of the first power supply generator or the second power supply generator controls a voltage of the first power supply or the second power supply so that the pixels do not emit light during the first period and the second period.

14. The display device as claimed in claim 4, wherein each of the pixels includes:
an organic light emitting diode having a cathode electrode coupled to the second power supply;
a pixel circuit configured to control an amount of current to be supplied to the organic light emitting diode in response to a data signal of the previous frame; and
a driver configured to store a data signal of a current frame and to deliver the data signal of the previous frame to the pixel circuit.

15. The display device as claimed in claim 14, wherein the pixel circuit includes:
a first transistor having a gate electrode coupled to a first node, a first electrode coupled to the first power supply, and a second electrode coupled to an anode electrode of the organic light emitting diode;
a second transistor coupled between the first node and the data lines and turned on when the first control signal is supplied; and
a first capacitor coupled between the first node and the first power supply.

16. The display device as claimed in claim 15, wherein the first transistor and the second transistor are PMOS transistors.

17. The display device as claimed in claim 14, wherein the pixel circuit includes:
a first transistor having a gate electrode coupled to a first node, a first electrode coupled to the first power supply, and a second electrode coupled to an anode electrode of the organic light emitting diode;
a second transistor coupled between the first node and the data lines and turned on when the first control signal is supplied; and
a first capacitor coupled between the first node and the anode electrode of the organic light emitting diode.

18. The display device as claimed in claim 17, wherein the first transistor and the second transistor are NMOS transistors.

19. The display device as claimed in claim 15, wherein the driver includes:
a third transistor coupled to the data lines and the second node and turned on when a scan signal is supplied;
a fourth transistor coupled between the second node and the first node and turned on when the second control signal is supplied; and
a second capacitor coupled between the second node and an initial power supply.

20. A method of driving an organic light emitting display device, the method comprising:
modifying bits of first data, supplied in response to pixel data, to generate second data including information indicative of threshold voltages and mobilities of driving transistors in a plurality of pixels, each of the pixels storing a data signal of a current frame during a light-emitting period and emitting light in response to a data signal of a previous frame;
generating data signals based on the second data; and
supplying the data signals to the pixels.

21. The method as claimed in claim 20, further comprising:
controlling bit values of the second data to compensate for the threshold voltages and mobilities of the driving transistors.

22. The method as claimed in claim 20, wherein the pixel data is stored in a memory before the display device is shipped.

23. The method as claimed in claim 22, wherein storing the pixel data in the memory includes:
supplying a reference data signal to the pixels;
measuring light emitted from the pixels in response to the reference data signal; and
generating the pixel data to compensate for light difference in the respective pixels.
